(19) United States
(12) Patent Application Publication
(10) Pub. No.: US 2018/0205313 A1
(43) Pub. Date: Jul. 19, 2018

(54) BATTERY CHARGER

(71) Applicant: Dyson Technology Limited, Wiltshire (GB)

(72) Inventors: Stephen GREETHAM, Gloucester (GB); Stephen BERRY, Swindon (GB); Hari Babu KOTTE, Swindon (GB); Ambatipudi RADHIKA, Swindon (GB)

(73) Assignee: Dyson Technology Limited, Wiltshire (GB)

(21) Appl. No.: 15/746,403

(22) PCT Filed: Jun. 30, 2016
(86) PCT No.: PCT/GB2016/051978

§ 371 Date: Jan. 19, 2018

(30) Foreign Application Priority Data
Jul. 21, 2015 (GB) 1512850.7

(51) Int. Cl. H02M 1/42; H02J 7/02; H02M 3/335; H02M 1/12

(52) U.S. Cl. CPC H02M 1/4241; H02J 7/022; H02M 2001/0058; H02M 3/33592; H02M 1/12; H02M 1/4266

(57) ABSTRACT

A battery charger comprising input terminals for connection to an AC source supplying an alternating input voltage, output terminals for connection to a battery to be charged, and a power factor correction (PFC) circuit connected between the input terminals and the output terminals. The battery charger monitors the voltage of the battery and operates in a first mode when the voltage is below a threshold. The battery charger then switches to a second mode when the voltage exceeds the threshold. The PFC circuit regulates an input current drawn from the AC source such that the waveform of the input current when operating in the first mode is different to that when operating in the second mode.

The present invention relates to a battery charger.

A battery charger may comprise a power factor correction (PFC) circuit that generates a regular output current for use in charging the battery whilst simultaneously drawing a sinusoidal input current from an AC source.

The present invention provides a battery charger comprising input terminals for connection to an AC source supplying an alternating input voltage, output terminals for connection to a battery to be charged, and a PFC circuit connected between the input terminals and the output terminals, wherein the battery charger monitors the voltage of the battery, the battery charger operates in a first mode when the voltage of the battery is below a threshold, the battery charger switches to a second mode when the voltage of the battery exceeds the threshold, the PFC circuit regulates an input current drawn from the AC source such that the input current has a first waveform when operating in the first mode and a second waveform when operating in the second mode, and the first waveform is different to the second waveform.

By employing different waveforms at different battery voltages, better control may be achieved over the peak input power, the peak input current and/or the total harmonic distortion of the input current. For example, when the battery voltage is relatively low, a waveform may be selected for the input current that seeks to reduce the peak input power and/or the peak input current at the expense of total harmonic distortion. As the battery voltage increases, the average input current must increase in order to achieve the same charge rate. If the average input current were increased without any change in the waveform, the total harmonic distortion of the input current, when expressed in absolute terms, would increase and may exceed regulatory limits. Accordingly, when the battery voltage is relatively high, a different waveform may be selected for the input current that seeks to decrease the total harmonic distortion at the expense of peak input power and/or peak input current.

The total harmonic distortion of the first waveform may be lower than that of the second waveform. This then has the advantage that, when the voltage of the battery is below the threshold, a higher charge rate may be achieved without exceeding the harmonic limits imposed by regulation. When the voltage of the battery subsequently exceeds the threshold, a slower charge rate may be employed by reducing the average value of the input current. Since the average value of the input current is reduced, a waveform having a higher total harmonic distortion may be employed that nevertheless continues to comply with regulatory limits. By employing a waveform with a higher total harmonic distortion, a lower peak input current may be achieved, thereby leading to lower I²R losses.

When operating in the second mode, the ratio of the peak input current to average input power may be lower than that when operating in the first mode. This has at least two potential benefits. First, as battery voltage increases, the input power required to maintain the same charge rate increases. Without any change to the waveform of the input current, the peak value of the input current may become excessively high at higher battery voltages. By employing a different waveform for which the ratio of the peak input current to average input power is lower, excessively high currents may be avoided and thus the components of the battery charger may be rated for lower current. Second, as noted in the preceding paragraph, a slower charge rate may be employed at higher battery voltages by reducing the average input current. Since the average input current is reduced, a waveform having a higher total harmonic distortion may be employed that nevertheless continues to comply with regulatory limits. Accordingly, it is possible to employ a waveform for which the ratio of peak input current to average input power is lower. This then has the benefit of reducing the peak input current and thus the I²R losses.

Each half-cycle of the first waveform and each half-cycle of the second waveform may comprise a single pulse. This then has the benefit of reducing the harmonic content of the input current, particularly the magnitude of the high-order harmonics.

Each half-cycle of the second waveform may comprise a single rectangular pulse. In addition to the advantages noted in the preceding paragraph, the use of a rectangular pulse has the advantage of minimising the peak input current and thus the I²R losses.

When measuring the battery voltage during charging, there is a discrepancy between the measured voltage and the actual voltage due to the internal impedance of the battery. In addition to this, switching of the PFC circuit is likely to introduce a small ripple on the voltage signal. The discrepancy between the measured voltage and the actual voltage may be unimportant at lower battery voltages. However, as the battery approaches full charge, the discrepancy may have adverse consequences. Accordingly, each cycle of the second waveform may comprise one or more off periods during which the amplitude of the input current is zero. The battery charger then measures the voltage of the battery during an off period. As a result, a more accurate measure of the battery voltage may be obtained.

Each half-cycle of the second waveform may comprise a single pulse located between two off periods. As a result, the input current may be kept in phase with the input voltage, thereby improving the power factor of the battery charger. The pulse may be rectangular, which has the advantage of minimising the peak input current and thus the I²R losses.

When operating in the second mode, the battery charger may stop drawing the input current when the voltage of the battery exceeds a fully-charged threshold and then resume drawing the input current when the voltage of the battery subsequently drops below a top-up threshold. This then has the advantage that charging of the battery is halted when the voltage reaches the fully-charged threshold. However, should the battery subsequently undergo voltage relaxation, charging is resumed such that the voltage of the battery is topped up to the fully-charged threshold.

The battery charger may stop and resume drawing the input current in synchrony with zero-crossings in the input voltage. This then avoids drawing abruptly a high input current from the AC source. Additionally, the harmonic content of the input current is reduced and the power factor of the battery charger is increased.

The first waveform may be one of a sine wave with third harmonic injection, a clipped sine wave, and a trapezoidal wave. This then has the advantage that the peak input power and/or the peak input current of the battery charger, for a given average input power, may be reduced. As a result, the battery charger may employ components rated for lower power and/or current, thereby reducing the size, weight and/or cost of the battery charger. Any departure from a sinusoid will increase the harmonic content of the input current. However, these particular waveforms are capable of providing a significant reduction in the peak input power and/or peak input current without increasing excessively the harmonic content.

When operating in the first mode, the PFC circuit may adjust the average value of the input current in response to changes in the voltage of the battery. As a result, the battery charger is better able to control the charge rate. The PFC circuit may increase the average value of the input current in response to an increase in the voltage of the battery. Consequently, a similar charge rate may be achieved during charging.

When operating in the second mode, the average value of the input current may be fixed. That is to say that the PFC circuit does not adjust the average value of the input current in response to changes in the battery voltage. This then simplifies the control of the PFC circuit.

The battery charger may generate an output current at the output terminals, and the output current may have a waveform defined by the multiplication of the input current and the input voltage and have a ripple of at least 50%. As a result, the waveform of the output current is periodic with a frequency twice that of the input current. Conventional wisdom dictates that charging a battery with currents having relatively large ripple reduces the lifespan of the battery. In particular, time-varying currents lead to increased heating, which adversely affects the electrolyte conductivity as well as the electrochemical reactions at the electrode-electrolyte interfaces. The present invention recognises that, contrary to conventional wisdom, it is possible to charge a battery with currents having relatively large ripple. In order to generate a regular output current, the PFC circuit of a conventional battery charger typically requires a capacitor of high capacitance. With the battery charger of the present invention, on the other hand, the PFC circuit may employ a capacitor of much smaller capacitance, or indeed no capacitor at all, thereby reducing the cost and size of the battery charger.

The battery charger may comprise a step-down DC-to-DC converter located between the PFC circuit and the output terminals. The voltage conversion ratio of the DC-to-DC converter may then be defined such that the peak value of the input voltage, when stepped down, is less than the minimum voltage of the battery. This then has the advantage that the PFC circuit is able to operate in boost mode to provide continuous current control.

The DC-to-DC converter may comprise a resonant converter having one or more primary-side switches that are switched at a constant frequency. Employing a resonant converter has the advantage that the desired voltage conversion ratio may be achieved through the turns ratio of the transformer. Additionally, a resonant converter is able to operate at higher switching frequencies than a comparable PWM converter and is capable of zero-voltage switching. By switching the primary-side switches at a constant frequency, a relatively simple controller may be employed by the DC-to-DC converter. Switching at a constant frequency is made possible because the DC-to-DC converter is not required to regulate or otherwise control the output voltage. In contrast, the DC-to-DC converter of a conventional power supply is generally required to regulate the output voltage and thus requires a more complex and expensive controller in order to vary the switching frequency.

The DC-to-DC converter may have one or more secondary-side switches that are switched at the same constant frequency as that of the primary-side switches. A relatively simple and cheap controller may therefore be employed on the secondary side. Moreover, a single controller could conceivably be employed to control both the primary-side and the secondary-side switches.

For the purposes of clarity, the following terms should be understood to have the following meanings. The term ‘waveform’ refers to the shape of a signal and is independent of the amplitude or phase of the signal. The terms ‘amplitude’ and ‘peak value’ are synonymous and refer to the absolute maximum value of the signal. The term ‘ripple’ is expressed herein as a peak-to-peak percentage of the maximum value of the signal. The term ‘average value’ refers to the average of the absolute instantaneous values of a signal over one cycle. Finally, the term ‘total harmonic distortion’ refers to the sum of all harmonic components of the signal expressed as a percentage of the fundamental component.

In order that the present invention may be more readily understood, embodiments of the invention will now be described, by way of example, with reference to the accompanying drawings, in which:

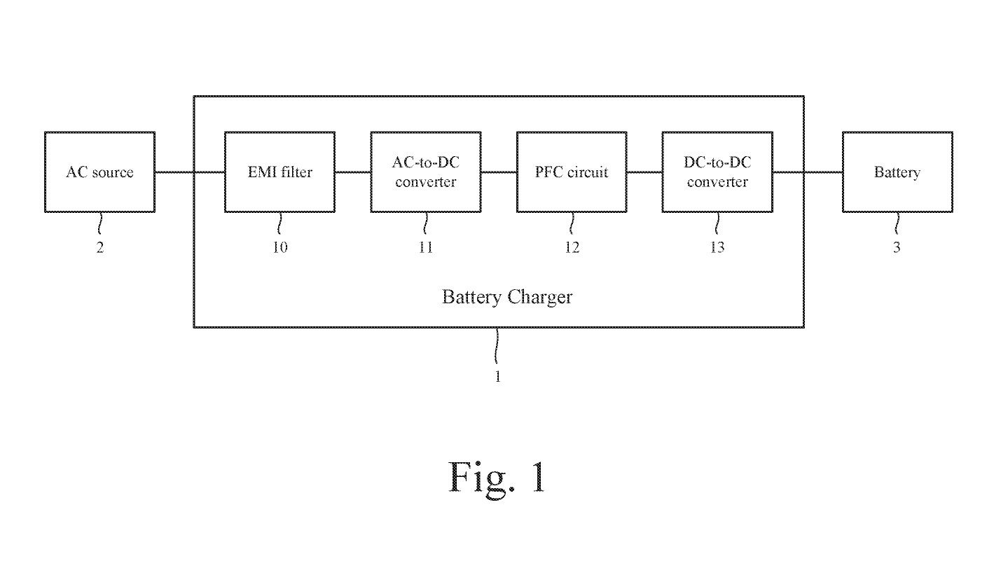

FIG. 1 is a block diagram of a battery charger in accordance with the present invention;

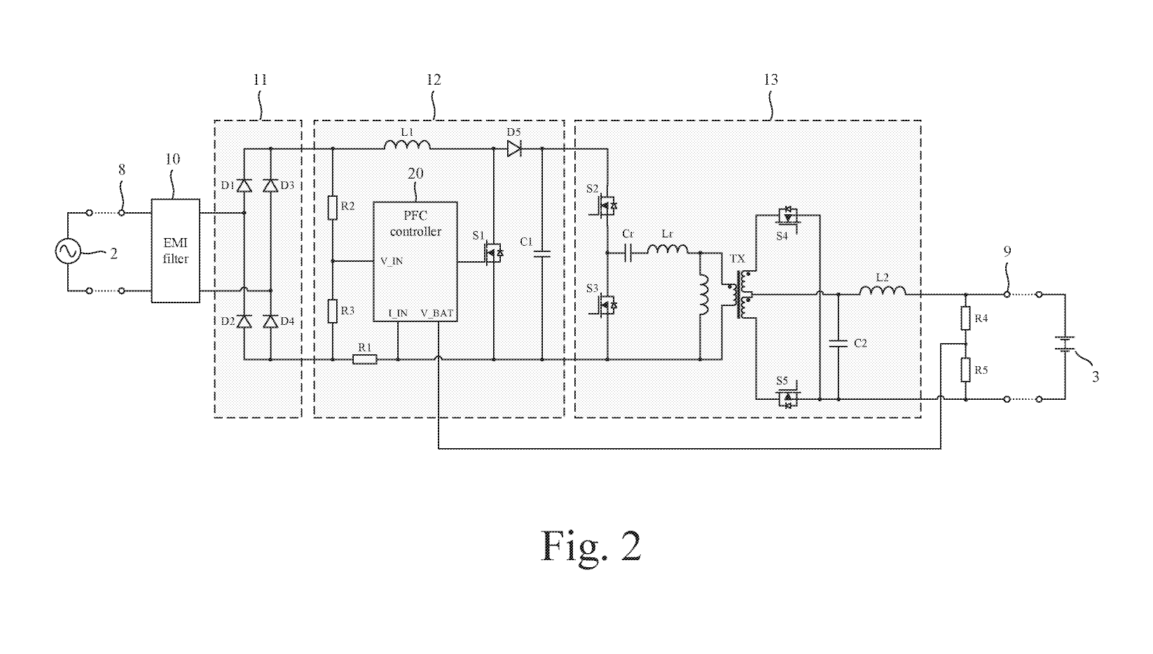

FIG. 2 is a circuit diagram of the battery charger;

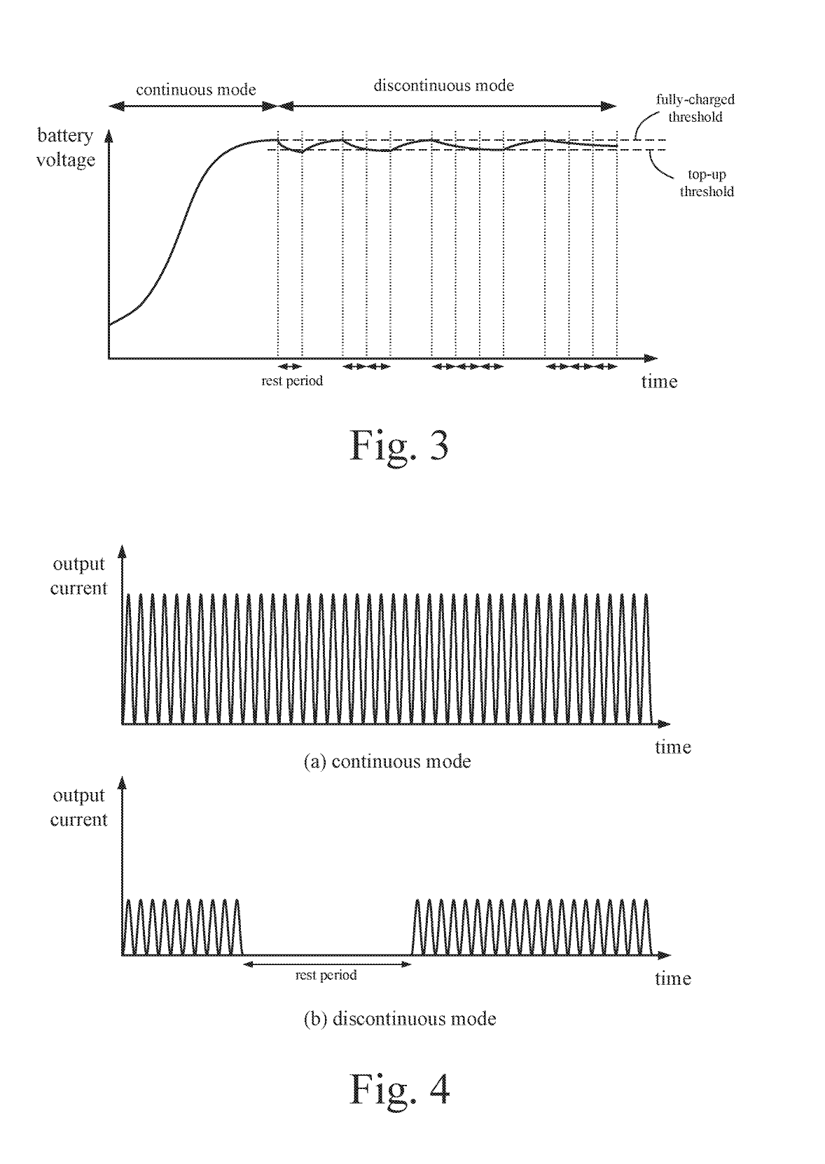

FIG. 3 illustrates the voltage of a battery charged by the battery charger;

FIG. 4 illustrates the output current of the battery charger when operating in (a) continuous mode and (b) discontinuous mode;

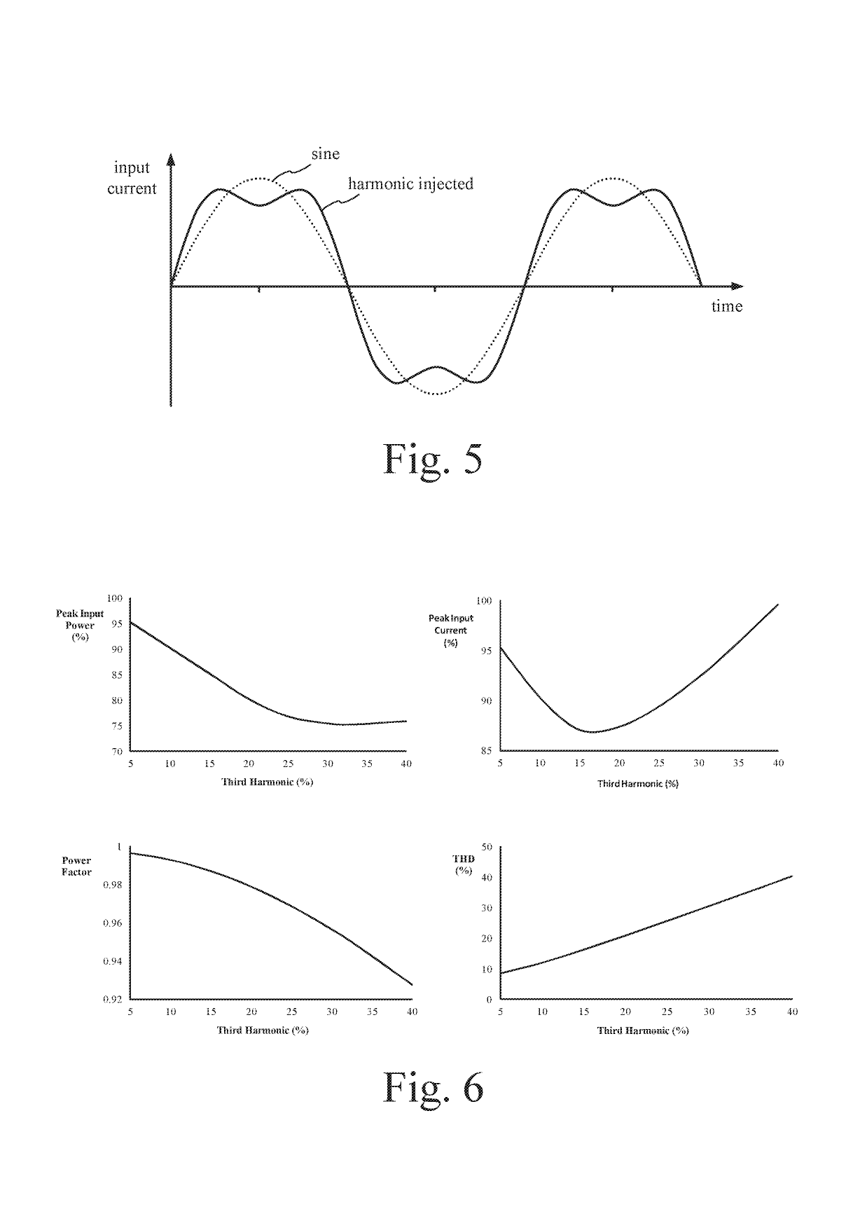

FIG. 5 illustrates a first alternative waveform for the input current drawn by the battery charger;

FIG. 6 illustrates how the peak input power, the peak input current, the power factor and the total harmonic distortion of the battery charger behave in response to changes in the magnitude of the third harmonic of the first alternative waveform;

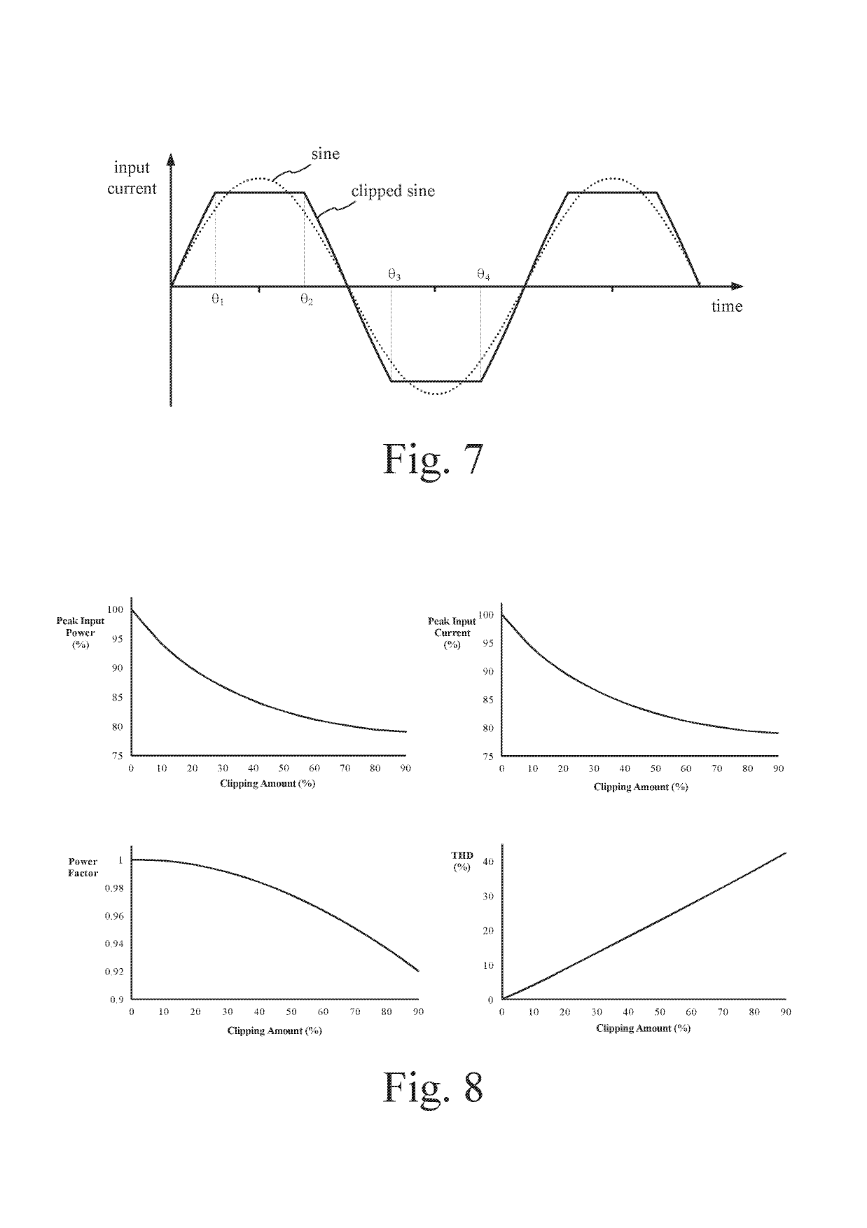

FIG. 7 illustrates a second alternative waveform for the input current drawn by the battery charger;

FIG. 8 illustrates how the peak input power, the peak input current, the power factor and the total harmonic distortion of the battery charger behave in response to changes in the clipping amount of the second alternative waveform;

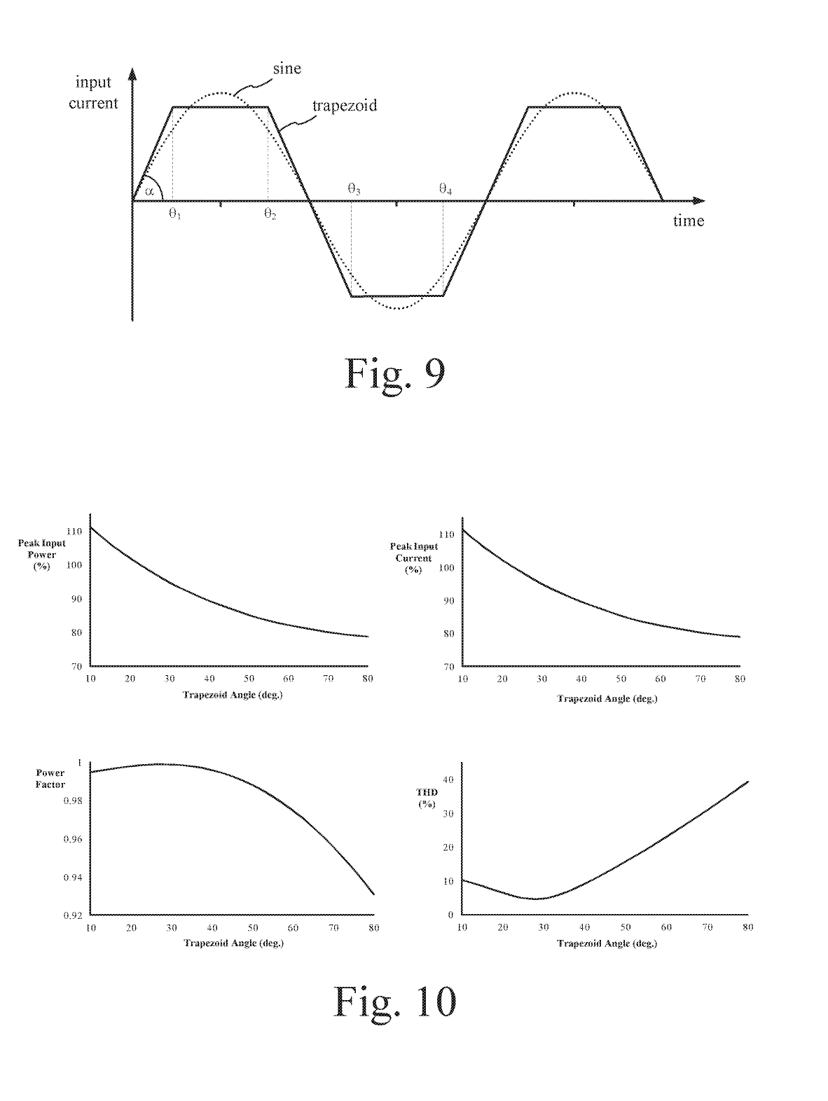

FIG. 9 illustrates a third alternative waveform for the input current drawn by the battery charger;

FIG. 10 illustrates how the peak input power, the peak input current, the power factor and the total harmonic distortion of the battery charger behave in response to changes in the internal trapezoid angle of the third alternative waveform;

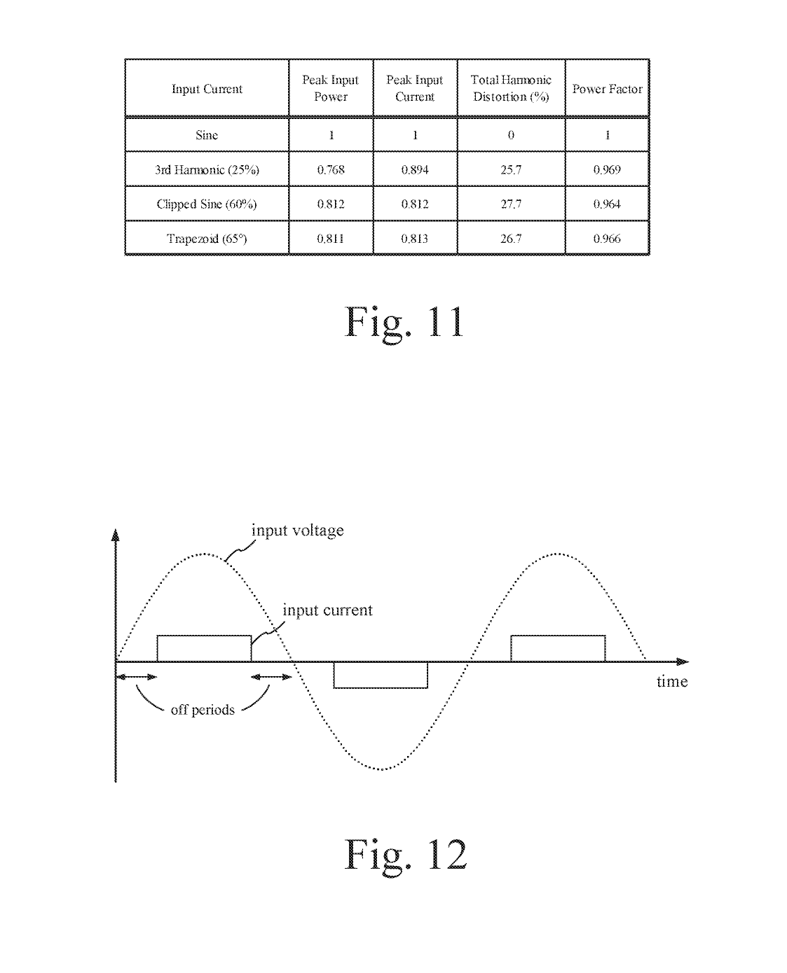

FIG. 11 details the peak input power, the peak input current, the power factor and the total harmonic distortion for various waveforms of the input current drawn by the battery charger;

FIG. 12 illustrates a fourth alternative waveform for the input current drawn by the battery charger;

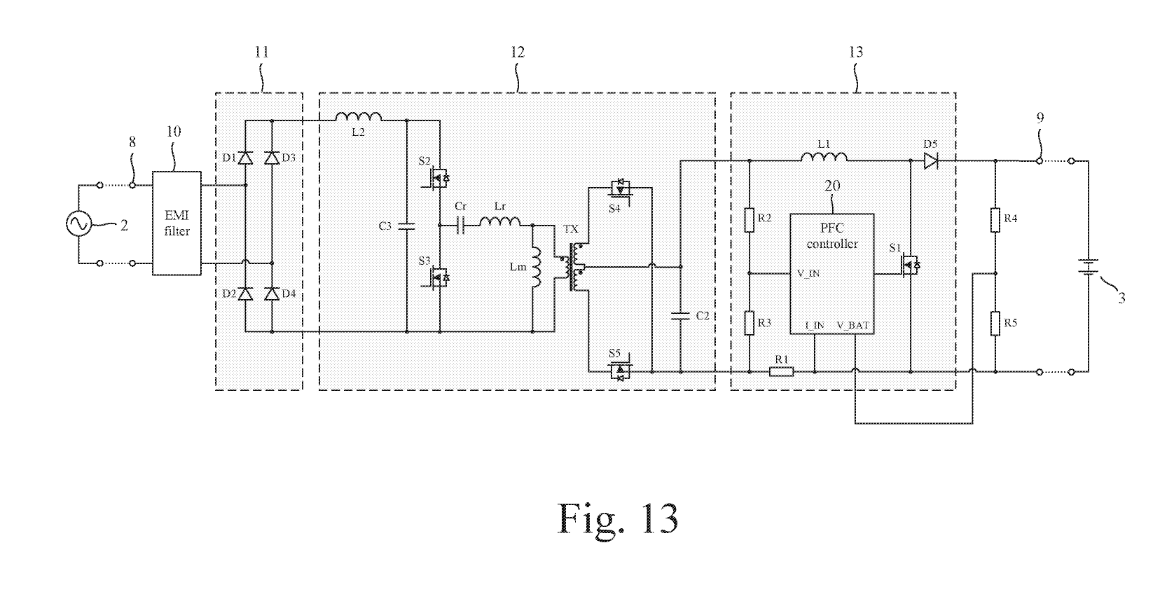

FIG. 13 is a circuit diagram of a first alternative battery charger in accordance with the present invention;

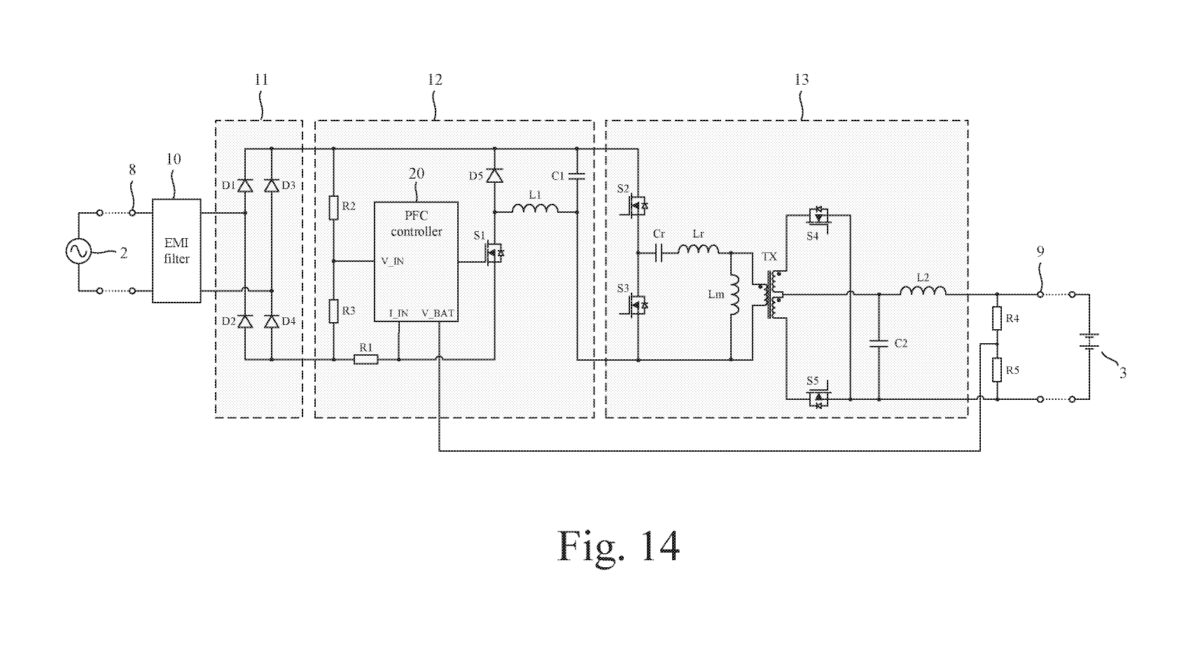

FIG. 14 is a circuit diagram of a second alternative battery charger in accordance with the present invention;

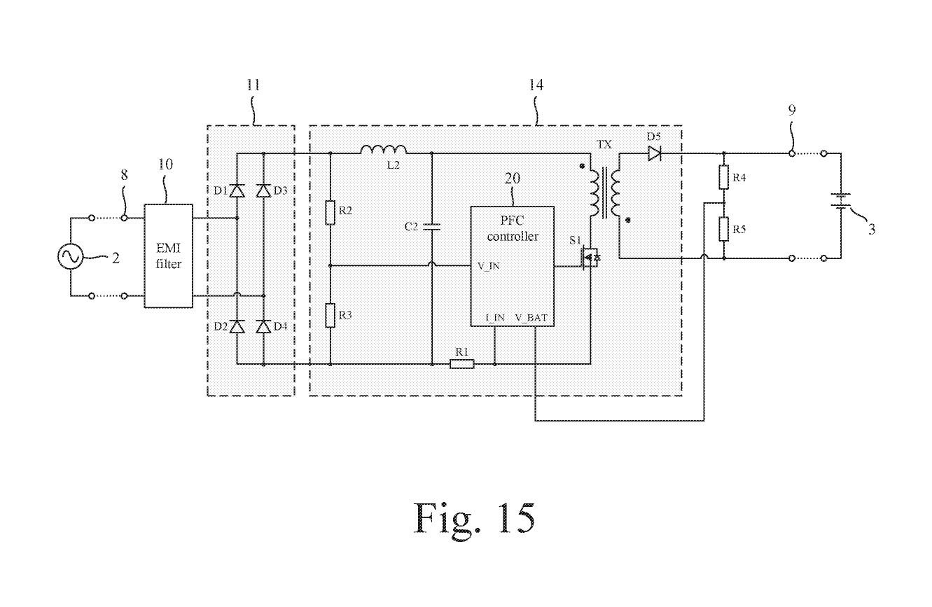

FIG. 15 is a circuit diagram of a third alternative battery charger in accordance with the present invention; and

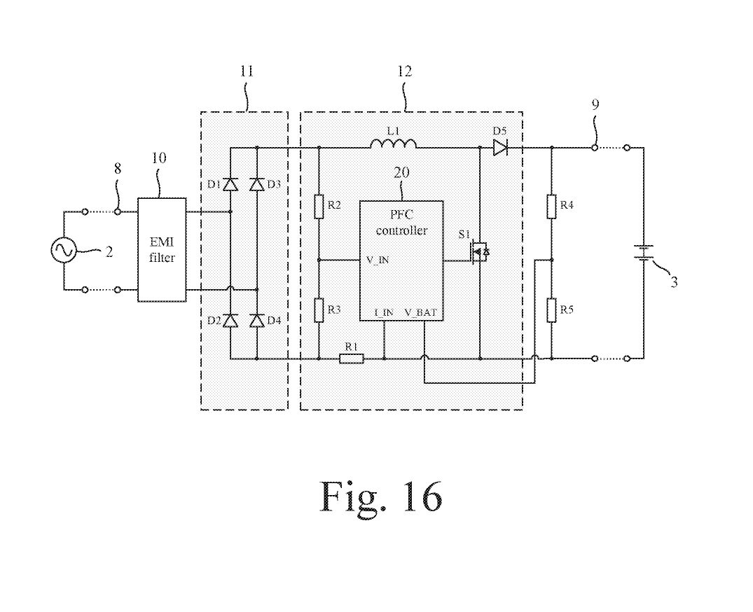

FIG. 16 is a circuit diagram of a fourth alternative battery charger in accordance with the present invention.

The battery charger 1 of FIGS. 1 and 2 comprises input terminals 8 for connection to an AC source 2, and output terminals 9 for connection to a battery 3 to be charged. The battery charger 1 further comprises an electromagnetic interference (EMI) filter 10, an AC-to-DC converter 11, a power factor correction (PFC) circuit 12, and a DC-to-DC converter 13 connected between the input terminals 8 and the output terminals 9.

The EMI filter 10 is used to attenuate high-frequency harmonics in the input current drawn from the AC source 2.

The AC-to-DC converter 11 comprises a bridge rectifier D1-D4 providing full-wave rectification.

The PFC circuit 12 comprises a boost converter located between the AC-to-DC converter 11 and the DC-to-DC converter 13. The boost converter comprises an inductor L1, a capacitor C1, a diode D5, a switch S1 and a control circuit. The inductor, capacitor, diode and switch are arranged in a conventional arrangement. Consequently, the inductor L1 is energised when the switch S1 is closed, and energy from the inductor L1 is transferred to the capacitor C1 when the switch S1 is opened. Opening and closing of the switch Si is then controlled by the control circuit.

The control circuit comprises a current sensor R1, a voltage sensor R2, R3, and a PFC controller 20. The current sensor R1 outputs the signal I_IN, which provides a measure of the input current drawn from the AC source 2. The voltage sensor R2, R3 outputs the signal V_IN, which provides a measure of the input voltage of the AC source 2. The current sensor R1 and the voltage sensor R2, R3 are located on the DC side of the AC-to-DC converter 11. Consequently, I_IN and V_IN are rectified forms of the input current and the input voltage. Both signals are output to the PFC controller 20. The PFC controller 20 scales V_IN in order to generate a current reference. The PFC controller 20 then uses the current reference to regulate the input current I_IN. There are various control schemes that the PFC controller 20 might employ in order to regulate the input current. For example, the PFC controller 20 might employ peak, average or hysteretic current control. Such control schemes are well known and it is not therefore the intention here to describe a particular scheme in any detail. The PFC controller 20 also receives the signal V_BAT, which provides a measure of the voltage of the battery 3 and is output by a further voltage sensor R4, R5. As described below, the PFC controller 20 regulates the input current drawn from the AC source 2 in response to changes in the battery voltage. This is achieved by adjusting the amplitude of the current reference (i.e. by scaling V_IN) in response to changes in V_BAT.

The DC-to-DC converter 13 comprises a half-bridge LLC series resonant converter that comprises a pair of primary-side switches S2,S3, a primary-side controller (not shown) for controlling the primary-side switches, a resonant network Cr,Lr, a transformer Tx, a pair of secondary-side switches S4,S5, a secondary-side controller (not shown) for controlling the secondary-side switches, and a low-pass filter C2,L2. The primary-side controller switches the primary-side switches S2,S3 at a fixed frequency defined by the resonance of Cr and Lr. Similarly, the secondary-side controller switches the secondary-side switches S4,S5 at the same fixed frequency so as to achieve synchronous rectification. The low-pass filter C2,L2 then removes the high-frequency current ripple that arises from the switching frequency of the converter 13.

The impedance of the DC-to-DC converter 13 is relatively low. As a consequence, the voltage at the output of the PFC circuit 12 is held at a level defined by the voltage of the battery 3. More specifically, the voltage at the output of the PFC circuit 12 is held at the battery voltage multiplied by the turns ratio of the DC-to-DC converter 13. In order to simplify the following discussion, the term ‘stepped battery voltage’ will be used when referring to the battery voltage, V_BAT, multiplied by the turns ratio, Np/Ns.

On opening the switch S1 of the PFC circuit 12, energy from the inductor L1 is transferred to the capacitor C1, causing the capacitor voltage to rise. As soon as the capacitor voltage reaches the stepped battery voltage, energy from the inductor L1 is transferred to the battery 3. Owing to the relatively low impedance of the DC-to-DC converter 13, the voltage of the capacitor C1 does not rise any further but is instead held at the stepped battery voltage. On closing the switch Si of the PFC circuit 12, the capacitor C1 discharges only when there is a difference between the capacitor voltage and the stepped battery voltage. As a result, the capacitor C1 continues to be held at the stepped battery voltage after the switch S1 has been closed. The voltage of the battery 3 is therefore reflected back to the PFC circuit 12.

In order that the PFC circuit 12 is able to control continuously the input current drawn from the AC source 2, it is necessary to maintain the capacitor voltage at a level greater than the peak value of the input voltage of the AC source 2. Since the capacitor C1 is held at the stepped battery voltage, it is necessary to maintain the stepped battery voltage at a level greater than the peak value of the input voltage. Moreover, this condition must be met over the full voltage range of the battery 3. Consequently, the turns ratio of the DC-to-DC converter 13 may be defined as:

Np/Ns>V_IN(peak)/V_BAT(min).

where Np/Ns is the turns ratio, V_IN(peak) is the peak value of the input voltage of the AC source 2, and V_BAT(min) is the minimum voltage of the battery 3.

The PFC circuit 12 ensures that the input current drawn from the AC source 2 is substantially sinusoidal. Since the input voltage of the AC source 2 is sinusoidal, the input power drawn from the AC source 2 by the battery charger 1 has a sine-squared waveform. Since the battery charger 1 has very little storage capacity, the output power of the battery charger 1 has substantially the same shape as the input power, i.e. the output power also has a sine-squared waveform. The output terminals 9 of the battery charger 1 are held at the battery voltage. Consequently, the battery charger 1 acts as a current source that outputs an output current having a sine-squared waveform. The waveform of the output current is therefore periodic with a frequency twice that of the input current and a ripple of 100%.

The battery charger 1 operates in one of two charging modes, depending on the voltage of the battery 3. When the voltage of the battery 3 is less than a fully-charged threshold the battery charger 1 operates in a first mode or continuous-charge mode, and when the voltage of the battery 3 is greater than the fully-charged threshold the battery charger 1 operates in a second mode or discontinuous-charge mode.

When operating in continuous-charge mode, the PFC circuit 12 draws an input current from the AC source 2 during each and every half-cycle of the input voltage. As a result, the waveform of the output current of the battery charger 1 is continuous. In addition, the PFC controller 20 regulates the input current such that the average value of the output current is constant. If the battery charger 1 were to draw a constant average input current, the average value of the output current would depend on the voltage of the battery 3. In particular, if the voltage of the battery 3 were to increase, the average value of the output current would decrease. Accordingly, in order to achieve a constant average value for the output current, the PFC controller 20 adjusts the input current drawn from the AC source 2 in response to changes in the voltage of the battery 3. More particularly, as the voltage of the battery 3 increases, the PFC controller 20 increases the average value of the input current such that the average value of the output current is constant. As a result, the battery 3 is charged with a constant average current.

When operating in discontinuous-charge mode, the PFC circuit 12 draws an input current from the AC source 2 during only some of the half-cycles of the input voltage. No input current is then drawn during the remaining half-cycles of the input voltage. As a result, the output current of the battery charger 1 is discontinuous.

When the battery charger 1 switches to discontinuous-charge mode (i.e. when the voltage of the battery 3 exceeds the fully-charged threshold for the first time), the PFC circuit 12 immediately stops drawing an input current from the AC source 2. As a result, no current is output by the battery charger 1 and thus charging of the battery 3 is halted. After a set period of time, which will hereafter be referred to as a rest period, the PFC controller 20 measures the voltage of the battery 3 via the V_BAT signal. If the battery voltage is less than a top-up threshold, the PFC circuit 12 resumes drawing an input current such that a current is again output by the battery charger 1. The voltage of the battery 3 therefore rises and when the voltage subsequently exceeds the fully-charged threshold, the PFC circuit 12 again stops drawing an input current and waits for the rest period. If, at the end of a rest period, the battery voltage is less than the top-up threshold, the PFC circuit 12 draws an input current such that a current is output by the battery charger 1. If, however, the battery voltage is greater than the top-up threshold at the end of a rest period, the PFC controller 20 waits a further rest period before re-sampling the battery voltage. If the battery voltage is greater than the top-up threshold after three rest periods, the PFC controller 20 concludes that the battery 3 is fully charged and ceases charging.

Each rest period allows the voltage of the battery 3 to relax before charging is recommenced. As a result, the state of charge of the battery 3 can be increased without subjecting to the battery 3 to excessive voltages. As the state of charge of the battery 3 increases, the degree of voltage relaxation during each rest period decreases. Eventually there comes at point at which the voltage relaxation is so small that the battery 3 is considered to be fully charged. In the present embodiment, this is deemed to have occurred if, after three rest periods, the voltage of the battery 3 has not dropped below the top-up threshold.

Each rest period corresponds to an integral number of half-cycles of the input voltage. As a result, the battery charger 1 stops and starts drawing the input current in synchrony with zero-crossings in the input voltage. This then avoids drawing abruptly a relatively high input current, which helps to maintain a high power factor and a low total harmonic distortion.

When operating in discontinuous mode, the PFC circuit 12 draws a lower input current in comparison to that drawn in continuous mode for the same battery voltage. As a result, the battery charger 1 outputs a lower output current. Overcharging of the battery 3 due to excessive overshoot of the fully-charged threshold may therefore be avoided. Additionally, lower temperatures within the battery 3 may be achieved due to the lower charge currents. In contrast to continuous mode, the PFC circuit 12 draws a constant average input current from the AC source 2. As a result, the output current of the battery charger 1 decreases as the voltage of the battery 3 increases. This then further reduces the risk of overshooting the fully-charged threshold.

FIG. 3 illustrates how the voltage of the battery 3 may vary with time during charging, whilst FIG. 4 illustrates the output current of the battery charger 1 when operating in (a) continuous mode and (b) discontinuous mode.

In the embodiment described above, the PFC controller 20 regulates the input current such that the waveform is sinusoidal. This then has the advantage that the battery charger 1 has a relatively high power factor. However, a disadvantage of drawing a sinusoidal input current is that, for a given average input power, the peak input power and the peak input current are relatively high. The PFC controller 20 may therefore regulate the input current such that the input current has an alternative waveform that reduces the ratio of the peak input power to the average input power and/or the ratio of the peak input current to the average input power. By reducing one or both of these ratios, the same average input power may be achieved for a lower peak input power and/or a lower peak input current. This then has the benefit that the battery charger 1 may employ components rated for lower power and/or current, thereby reducing the size, weight and/or cost of the battery charger 1. Of course, reducing the peak input power or the peak input current is not without its disadvantages. In particular, any departure from a sinusoid will decrease the power factor and increase the harmonic content of the input current. Many countries have regulations (e.g. IEC61000-3-2) that impose strict limits on the harmonic content of the current that may be drawn from the mains power supply. The PFC controller 20 may therefore regulate the input current so as to reduce one or both of the aforementioned ratios without increasing the harmonic content beyond that imposed by regulation. Three waveforms for the input current will now be described that are particularly well suited to this task, each of which has its own advantages and disadvantages.

FIG. 5 illustrates a first alternative waveform for the input current. The waveform comprises a sine wave with the addition or injection of a third harmonic and may be defined as:

I=sin(θ)+A.sin(3θ), 0<θ23 2π

where A is a scaling factor that defines the relative magnitude of the third harmonic. The introduction of the third harmonic has no effect on the average value of the input current. That is to say that the average value of the input current is unchanged by the introduction or magnitude of the third harmonic. As illustrated in FIG. 6, the magnitude of the third harmonic does, however, influence the peak input power, the peak input current, the total harmonic distortion and the power factor.

The magnitude of the third harmonic that is employed by the PFC controller 20 will depend on several factors. Chief among those is the required average input power and the harmonic content that is permitted by regulation. For a given magnitude of third harmonic, the total harmonic distortion increases as the average input power increases. Consequently, for a higher average input power, the PFC controller 20 may be required to employ a lower magnitude for the third harmonic. The magnitude of the third harmonic employed by the PFC controller 20 may also depend on a desired power factor and/or whether the input current should be optimised for peak input power, peak input current or a combination of the two. For example, if the input current is optimised for peak input power, the PFC controller 20 may set the relative magnitude of the third harmonic to 35.8% (i.e. A=0.358). Alternatively, if the input current is optimised for peak input current, the PFC controller 20 may set the relative magnitude of the third harmonic to 17.5% (i.e. A=0.175). A relative magnitude of between 20% and 30% (i.e. 0.2≤A≤0.3) for the third harmonic provides a good balance between the competing factors of peak input power, peak input current, and total harmonic distortion.

FIG. 7 illustrates a second alternative waveform for the input current. The waveform comprises a clipped sine wave and may be defined as:

$$I = \{ \begin{matrix}A \cdot sin ( θ ) , & 0 < θ \leq {θ}_{1} \\ B , & {θ}_{1} < θ \leq {θ}_{2} \\ A \cdot sin ( θ ) , & {θ}_{2} < θ \leq {θ}_{3} \\ - B , & {θ}_{3} < θ \leq {θ}_{4} \\ A \cdot sin ( θ ) , & {θ}_{4} < θ \leq 2 π\end{matrix}$$

where A is the amplitude of the sine wave, and B is the value at which the sine wave is clipped.

Since the sine wave is clipped, the average input power generated by the input current is reduced in comparison to that generated by a sinusoidal input current. The amplitude of the clipped sine wave is therefore increased in order to compensate. This can be seen in FIG. 7, in which the clipped sine wave is illustrated alongside a sine wave having the same average input power. As the amount of clipping increases (i.e. as the value of B increases), the amplitude of the sine wave (i.e. the value of A) must also increase so as to maintain the same average input power.

As illustrated in FIG. 8, the amount by which the sine wave is clipped (i.e. the ratio of B/A) influences the peak input power, the peak input current, the total harmonic distortion, and the power factor. The amount of clipping employed by the PFC controller 20 will again depend on several factors, such as the required input power, the harmonic content that is permissible, and the desired power factor. In contrast to the first alternative waveform, the peak input power and the peak input current behave in a similar manner to changes in the clipping amount. It is not therefore necessary to optimise the input current for just one of the peak input power and peak input current.

FIG. 9 illustrates a third alternative waveform for the input current. The waveform comprises a trapezoidal wave and may be defined as:

$$I = \{ \begin{matrix}A \cdot θ \cdot tan ( α ) , & 0 < θ \leq {θ}_{1} \\ B , & {θ}_{1} < θ \leq {θ}_{2} \\ B - A \cdot ( θ - {θ}_{2} ) \cdot tan ( α ) , & {θ}_{2} < θ \leq {θ}_{3} \\ - B , & {θ}_{3} < θ \leq {θ}_{4} \\ - B + A \cdot ( θ - {θ}_{4} ) \cdot tan ( α ) , & {θ}_{4} < θ \leq 2 π\end{matrix}$$

where α is the internal acute angle of the trapezoid, A is a scaling constant, and B is the height of the trapezoid.

The average input power generated by the waveform is defined by the area of the trapezoid, which in turn is defined by the internal angle (α) and the height of the trapezoid (B). Consequently, for a given input power, the waveform may be defined solely by the internal angle or the height. This is similar to the clipped sine waveform in which, for a given input power, the waveform may be defined by either the amplitude or the clipping amount.

As illustrated in FIG. 10, the size of the internal angle influences the peak input power, the peak input current, the total harmonic distortion, and the power factor. As described above in connection with the other waveforms, the internal angle employed by the PFC controller 20 will depend on several factors, such as the required input power, the harmonic distortion that is permissible, and the desired power factor. As with the clipped sine waveform, the peak input power and the peak input current behave in a similar manner to changes in the internal angle. As a result, it is not necessary to optimise the input current for just one of the peak input current and the peak input power.

In the primary embodiment described above, in which the PFC circuit 12 draws an input current having a sinusoidal waveform, the PFC controller 20 adjusts the average value of the input current in response to changes in the voltage of the battery 3. This is achieved by adjusting the amplitude of the input current drawn from the AC source 2. Similarly, where the PFC circuit 12 draws an input current having an alternative waveform, the PFC controller 20 adjusts the average value of the input current in response to changes in the voltage of the battery 3. Again, this is achieved by adjusting the amplitude of the input current drawn from the AC source 2. In addition to the amplitude of the input current, the PFC controller 20 may adjust the relative magnitude of the third harmonic, the amount of clipping, or the internal angle of the input current. If these parameters were fixed, the absolute magnitude of harmonic distortion would increase as the average input power increases. The PFC controller 20 may therefore decrease these parameters as the required input power increases. This then has the advantage that lower peak currents (and thus lower I²R losses) can be achieved at lower input powers and yet excessive harmonic distortion can be avoided at higher input powers. So, for example, when the battery charger 1 operates in continuous current mode, the PFC controller 20 may decrease the magnitude of the third harmonic as the voltage of the battery 3 increases.

The table illustrated in FIG. 11 provides a comparison of the four different waveforms for the input current. The amplitudes of the waveforms have been scaled so as to generate the same average input power, and the values for the peak input power and the peak input current have been normalised relative to those values for the sine wave. The amount of harmonic injection (25%), the amount of clipping (60%) and the internal angle (65 degrees) were chosen so as to achieve a similar total harmonic distortion and power factor. As a result, a fairer comparison can be made of the peak input power and the peak input current for each waveform. As is borne out by FIG. 11, the sine wave has the advantage of providing a higher power factor and lower harmonic distortion, but the disadvantage of providing a higher peak input power and a higher peak input current. Each of the other three waveforms has the advantage of providing a lower peak input power and a lower peak input current, but the disadvantage of a higher harmonic distortion and a lower power factor. Each of the alternative waveforms has its own advantages and disadvantages, which will now be discussed.

As is evident from FIG. 11, the harmonic-injected waveform provides the greatest reduction in peak input power but the smallest reduction in peak input current. Even if the magnitude of the third harmonic were optimised for peak input current (e.g. set to 17.5%), the peak input current would still be higher than that listed in FIG. 11 for the clipped sine and trapezoid waveforms. The harmonic-injected waveform is therefore particularly advantageous where a reduction in peak input power is the primary concern. By reducing the peak input power, a significant reduction in size may be achieved for the transformer Tx of the DC-to-DC converter 13, thereby reducing the size and weight of the battery charger 1. A disadvantage of the harmonic-injected waveform is that, in comparison to the other waveforms, it is more difficult to implement. In order to generate the harmonic-injected waveform, it is necessary to first generate the third harmonic and then add it the fundamental. This may be done digitally within the PFC controller 20. For example, the PFC controller 20 may store the harmonic-injected waveform in a lookup table that is indexed with time. However, this then requires a PFC controller 20 having additional peripherals and larger memory.

The values listed in FIG. 11 for the clipped sine and the trapezoid waveforms are almost indistinguishable. This is not surprising since, as can be seen in FIGS. 7 and 9, the two waveforms are similar in shape, particularly when the clipping amount is 60% and the internal angle is 65 degrees. The two waveforms each provide a significant reduction to the peak input power and the peak input current. Accordingly, either waveform may be employed where a reduction in both peak input power and peak input current is desirable. The clipped sine waveform has the advantage that it is relatively simple to implement in analogue. For example, a comparator may be used to clip the V_IN signal in order to generate the current reference. The trapezoid waveform is also relatively straightforward to implement in analogue. For example, the current reference may be generated using a square-wave signal generator synchronised to the input voltage, and a slew-rate limited amplifier. Alternatively, the clipped sine and trapezoid waveforms may be generated digitally using, for example, lookup tables.

The input current drawn by the PFC circuit 12 may have a different waveform when operating in continuous mode and discontinuous mode. For example, irrespective of the waveform used in continuous mode, the PFC circuit 12 may employ a square or rectangular wave for the current reference when operating in discontinuous mode. Both of these waveforms have the advantage of significantly reducing the peak input current. The disadvantages, however, are that the power factor is significantly reduced and the total harmonic distortion is significantly increased. Nevertheless, when operating in discontinuous mode, the input current drawn from the AC source 2 is comparatively low. It may therefore be possible to the employ a square or rectangular wave whilst complying with the harmonic limits imposed by regulation.

In addition to employing different waveforms when operating in continuous mode and discontinuous mode, the PFC circuit 12 may employ different waveforms for the input current when operating within each mode. For example, when operating in continuous mode, the PFC circuit 12 may draw an input current having a first waveform when the voltage of the battery 3 is relatively low, and a second waveform when the voltage of the battery 3 is relatively high. The first waveform may then be selected so as to reduce the peak input current at the expense of total harmonic distortion. As the battery voltage increases, the input current must increase in order to achieve the same charge rate. Without any change in the waveform of the input current, the total harmonic distortion, when expressed in absolute terms, may exceed regulatory limits at higher input currents. The second waveform may therefore be selected so as to reduce the total harmonic distortion at the expense of peak input current. As a further example, the first waveform may be a clipped sine wave or trapezoid wave, which provides a significant reduction in the peak input current. As the voltage of the battery 3 increases, the input power must increase if the same charge rate is to be achieved. The second waveform may therefore be a harmonic-injected wave, which provides an improved reduction in the peak input power. As a result, the components of the battery charger 1 may be rated for lower power, whilst lower currents and thus lower losses may be achieved at lower battery voltages.

When measuring the voltage of the battery 3 during charging, there is a discrepancy between the measured voltage and the actual voltage due to the internal impedance of the battery 3. In addition to this, there is a small ripple on the V_BAT signal due to switching of the PFC switch S1. When operating in continuous mode, this discrepancy between the measured voltage and actual voltage is unimportant. However, when operating in discontinuous mode, the discrepancy can have adverse consequences, particularly when the top-up threshold and the fully-charged threshold are close together. Accordingly, in order to obtain a more accurate measure of the battery voltage, the PFC circuit 12 may draw an input current having a waveform that comprises one or more off periods during each cycle. The amplitude of the input current is zero during each off period, i.e. no input current is drawn from the AC source 2 during each off period. The PFC controller 20 then measures the voltage of the battery 3 (i.e. samples the V_BAT signal) during one or more of the off periods. As a result, a more accurate measure of the battery voltage may be obtained.

FIG. 12 illustrates a possible waveform for the input current when the battery charger 1 operates in discontinuous mode. Each half-cycle of the waveform comprises a single rectangular pulse located between two off periods. As noted above, the use of a rectangular pulse has the benefit of significantly reducing the peak input current and thus the I²R losses. By employing a single pulse that is located between two off periods, a relatively good power factor may be achieved. The voltage of the battery 3 may then be measured by the PFC controller 20 at each zero-crossing in the input voltage.

Whilst a particular embodiment has thus far been described, various modifications are possible without departing from the scope of the invention as defined by the claims. For example, whilst the provision of the EMI filter 10 has particular benefits and may indeed be required for regulatory compliance, it will be apparent from the discussions above that the EMI filter 10 is not essential and may be omitted.

In the embodiment described above, the PFC circuit 12 is located on the primary side of the DC-to-DC converter 13. Conceivably, however, the PFC circuit 12 may be located on the secondary side, as illustrated in FIG. 13. Although the PFC circuit 12 may be located on the secondary side, currents and thus losses will inevitably be higher.

The battery charger 1 comprises an AC-to-DC converter 11 in the form of a bridge rectifier. However, where the PFC circuit 12 is located on the primary side of the DC-to-DC converter 13, the AC-to-DC converter 11 and the PFC circuit 12 may be replaced with a single bridgeless PFC circuit.

The PFC circuit 12 illustrated in FIGS. 2 and 13 comprises a boost converter. However, the PFC circuit 12 may equally comprise a buck converter, as illustrated in FIG. 14. It will therefore be apparent to a person skilled in the art that alternative configurations for the PFC circuit 12 are possible.

The DC-to-DC converter 13 has a centre-tapped secondary winding, which has the advantage that rectification may be achieved using two rather than four secondary-side devices. Rectification on the secondary side is then achieved using switches S4,S5 rather than diodes. Switches S4,S5 have the advantage of lower power losses, but the disadvantage of requiring a controller. However, since the primary-side switches S2,S3 operate at a fixed frequency, the secondary-side switches S4,S5 may also operate at a fixed frequency. Consequently, a relatively simple and cheap controller may also be employed on the secondary side. Moreover, a single, relatively cheap controller could conceivably be used to control both the primary-side and the secondary-side switches. In spite of these advantages, DC-to-DC converter 13 could comprise a non-tapped secondary winding and/or the secondary-side devices may be diodes. Moreover, rather than an LLC resonant converter, the DC-to-DC converter 13 may comprise an LC series or parallel resonant converter, or a series-parallel resonant converter.

In the embodiments described above, the battery charger 1 comprises a PFC circuit 12 that provides power factor correction and a DC-to-DC converter 13 that steps down the voltage output by the PFC circuit 12. FIG. 15 illustrates an alternative embodiment in which a single converter 14 serves as both a PFC circuit and a DC-to-DC converter. The converter 14 is generally referred to as a flyback converter and has a conventional configuration, with one exception. The flyback converter 14 does not comprise a secondary-side capacitor. The flyback converter 14 comprises a PFC controller 20 for controlling the primary-side switch S1. The operation of the PFC controller 20 is largely unchanged from that described above. In the embodiments described above, the PFC controller 20 operates in continuous-conduction mode. In contrast, the PFC controller 20 of the flyback converter 14 operates in discontinuous-conduction mode. However, in all other respects the operation of the PFC controller 20 is unchanged. In spite of the advantages of the flyback converter 14 (e.g. fewer components and simpler control), the converter 14 suffers from the disadvantage that the transformer Tx is responsible for storing all energy that is transferred from the primary side to the secondary side. Consequently, as the required output power of the battery charger 1 increases, the size of the transformer and/or the switching frequency must increase. The provision of a flyback converter 14 is therefore advantageous for relatively low output powers (e.g. below 200 W). Where higher output powers are required, an alternative topology, such as that illustrated in FIG. 2, 13 or 14, is preferable.

Returning to the embodiments illustrated in FIGS. 2, 13 and 14, the provision of a DC-to-DC converter 13 has the advantage that the battery charger 1 may be used to charge a battery 3 having a voltage that is lower than the peak value of the input voltage. However, there may be applications for which the DC-to-DC converter 13 may be omitted. FIG. 16 illustrates an embodiment in which the DC-to-DC converter 13 is omitted. Since the DC-to-DC converter 13 is omitted, the PFC circuit 12 no longer requires a capacitor. In order that the PFC circuit 12 can continue to control current continuously, the minimum operating voltage of the battery 3 must be greater than the peak value of the input voltage of the AC source 2, i.e. V_BAT(min)>V_IN(peak). Consequently, if the AC source 2 is a mains power supply providing a peak voltage of 120 V, the battery 3 must have a minimum voltage of at least 120 V. Whilst such an arrangement is suitable only for charging high-voltage batteries, there may be some applications for which this arrangement is both practical and advantageous.

In all of the embodiments described above, the output current of the battery charger 1 has a ripple of 100%. This arises because the battery charger 1 has little or no storage capacitance. Conceivably, the battery charger 1 may output an output current having a smaller ripple. This may be desirable for at least two reasons. First, a smaller current ripple may help prolong the life of the battery 3. Second, for the same average output power, the peak value of the output current will be smaller and thus a smaller and/or cheaper filter inductor L2, having a lower current rating, may be used. Decreasing the ripple in the output current may be achieved by operating the DC-to-DC converter 13 at a frequency higher than resonance. This then increases the impedance of the DC-to-DC converter 13, thereby allowing a voltage differential to arise between the PFC circuit 12 and the battery 3. This voltage differential may then be used to shape the current output by the battery charger 1 such that it has a ripple less than 100%. However, any reduction in ripple will require additional capacitance. Accordingly, the battery charger 1 is preferably configured such that the output current has a ripple of least 50%.

1. A battery charger comprising input terminals for connection to an AC source supplying an alternating input voltage, output terminals for connection to a battery to be charged, and a power factor correction (PFC) circuit connected between the input terminals and the output terminals, wherein the battery charger monitors the voltage of the battery, the battery charger operates in a first mode when a voltage of the battery is below a threshold, the battery charger switches to a second mode when the voltage of the battery exceeds the threshold, the PFC circuit regulates an input current drawn from the AC source such that the input current has a first waveform when operating in the first mode and a second waveform when operating in the second mode, and the first waveform is different to the second waveform.

2. The battery charger of claim 1, wherein a total harmonic distortion of the first waveform is lower than a total harmonic distortion of the second waveform.

3. The battery charger of claim 1, wherein a ratio of the peak input current to an average input power when operating in the second mode is lower than that when operating in the first mode.

4. The battery charger of claim 1, wherein the first and second waveforms each include a plurality of half-cycles, wherein each half-cycle of the first waveform and each half-cycle of the second waveform comprise a single pulse.

5. The battery charger of claim 4, wherein each half-cycle of the second waveform comprises a single rectangular pulse.

6. The battery charger of claim 4, wherein the second waveform includes a plurality of cycles and each cycle of the second waveform comprises one or more off periods, an amplitude of the input current is zero during each off period, and the battery charger measures the voltage of the battery during an off period.

7. The battery charger of claim 6, wherein each half-cycle of the second waveform comprises a single pulse located between two off periods.

8. The battery charger of claim 7, wherein, the pulse is rectangular.

9. The battery charger of claim 1, wherein when operating in the second mode, the battery charger stops drawing the input current when the voltage of the battery exceeds a fully-charged threshold, and the battery charger resumes drawing the input current when the voltage of the battery drops below a top-up threshold.

10. The battery charger of claim 9, wherein the battery charger stops and resumes drawing the input current in synchrony with zero-crossings in the input voltage.

11. The battery charger of claim 1, wherein the first waveform is one of a sine wave with third harmonic injection, a clipped sine wave, and a trapezoidal wave.

12. The battery charger of claim 1, wherein when operating in the first mode, the PFC controller adjusts an average value of the input current in response to changes in the voltage of the battery.

13. The battery charger of claim 12, wherein the PFC controller increases the average value of the input current in response to an increase in the voltage of the battery.

14. The battery charger of claim 1, wherein when operating in the second mode, an average value of the input current is fixed.

15. The battery charger of claim 1, wherein the battery charger generates an output current at the output terminals, and the output current has a waveform defined by the multiplication of the input current and the input voltage and has a ripple of at least 50%.

16. The battery charger of claim 1, wherein the battery charger comprises a step-down DC-to-DC converter having a voltage conversion ratio greater than a peak value of the input voltage divided by a minimum voltage of the battery.

17. The battery charger of claim 1, wherein the battery charger comprises a step-down DC-to-DC converter having one or more primary-side switches that are switched at a constant frequency.

18. The battery charger of claim 17, wherein the DC-to-DC converter has one or more secondary-side switches that are switched at the same constant frequency.
